(19) United States
(12) Patent Application Publication
(10) Pub. No.: US 2011/0231250 A1
(43) Pub. Date: Sep. 22, 2011

(54) System and Method for Displaying Advertisements on a User Device Based on User Preferences While Operative by the User

(75) Inventors: Tuvia Elbaum, Jerusalem (IL); Yitzchak Kempinski, Geva Binyamin (IL)

(73) Assignee: TEXTAWAY, LTD., Geva Binyamin (IL)

(21) Appl. No.: 13/047,289

(22) Filed: Mar. 14, 2011

Related U.S. Application Data
(60) Provisional application No. 61/315,313, filed on Mar. 18, 2010.

(51) Int. Cl. G06Q 30/00

(52) U.S. Cl. 705/14.48; 705/14.49; 705/14.64

(57) ABSTRACT

A method for displaying advertisements on a user device. The method includes generating at least one window frame on the user device by an agent, wherein the at least one window frame is configurable by a user of the user device; periodically communicating with an advertisement management server (AMS) requesting to provide at least one advertisement and its associated metadata; displaying, upon determination that a user is interacting with the user device, the at least one advertisement on the at least one window frame based in part on the metadata; and generating a message of consumption for debiting an advertisement campaign account of the at least one advertisement for the viewing of the at least one advertisement and for crediting a user account of the user for the viewing of the at least one advertisement; and sending the message of consumption to the AMS.

### CROSS-REFERENCE TO RELATED APPLICATIONS

This application claims the benefit of U.S. provisional application No. 61/315,313, filed on Mar. 18, 2010, the contents of which are hereby incorporated by reference.

### TECHNICAL FIELD

The invention relates generally to advertising in a network environment, and more particularly to the providing of advertisements and control thereof to a user device where the advertisements are displayed in a personalized dedicated viewing frame.

### BACKGROUND OF THE INVENTION

The ubiquity of access to content on the world wide web (WWW) via the Internet as well as a variety of other networks, which includes local networks, wireless networks, cellular networks and the like, provides many opportunities for delivery of information, services and goods to end users. As a result, a typical user spends an increasing amount of time in front of a user device such as a personal computer (PC) personal digital assistant (PDA), mobile phone, smart phone, and other such devices that provide viewable or audio able content. Consequently, there is an ever-increasing demand from advertisers to be able to advertise to users through such mediums.

Various solutions have been proposed for delivery of such advertisements as well as for ways to indirectly measure actual viewing of such advertisements. Today's users receive such advertisements, for example, and without limitation, while surfing the web using their browser of choice on a user device of choice. Advertisements are displayed regardless of the user's preferences and are mostly ignored. At best, advertisements are viewed while surfing a website, therefore an advertiser aiming to reach a customer for more than the seconds to minutes that a user is surfing a specific website must advertise on many different websites. Furthermore, the advertiser has to make tough decisions regarding which websites to choose. Naturally, the effectiveness of the advertising is limited to the web browsing time and hence exposure is limited by definition. This immediately results in a low value the advertisers are willing to give to any kind of advertisement provided on the WWW network.

In view of the limitations of the prior art it would be advantageous to provide a solution where advertisements are confirmed to be shown to a viewer receiving targeted advertisements, delivered when and how the user is willing to view such advertisements. It would be further advantageous if such viewing of an advertisement would be also tied to the advertising campaign.

### SUMMARY OF THE INVENTION

Certain embodiments of the invention include a method for displaying advertisements on a user device. The method includes generating at least one window frame on the user device by an agent, wherein the at least one window frame is configurable by a user of the user device; periodically communicating with an advertisement management server (AMS) requesting to provide at least one advertisement and its associated metadata; displaying, upon determination that a user is interacting with the user device, the at least one advertisement on the at least one window frame based in part on the metadata; and generating a message of consumption for debiting an advertisement campaign account of the at least one advertisement for the viewing of the at least one advertisement and for crediting a user account of the user for the viewing of the at least one advertisement; and sending the message of consumption to the AMS.

Certain embodiments of the invention also include a user device for display of advertisements. The user device includes a memory for storing an agent, the agent allowing a user of the user device to cause the display of at least a window frame; a processing unit for execution of at least the agent; a network interface connected to the processing unit for accessing at least an advertisement management server (AMS) for retrieving at least one advertisement and corresponding metadata, wherein the retrieved advertisement and corresponding metadata are saved in the memory; a display connected to the processing unit and the memory for the display of the at least an advertisement stored in the memory on at least one window frame activated by the agent of the user device, wherein the agent causes to display of the at least one advertisement on the at least one window frame opened by the agent upon determination that the user is interacting with the user device, wherein the agent generates a message of consumption respective of consumption of the at least one advertisement by the user of the user device.

Certain embodiments of the invention also include a method for authorization the display of advertisements on at least one user device, the method is performed by an AMS. The method comprises sending at least one advertisement and associated metadata to a user device requesting the at least one advertisement, wherein the at least one advertisement being sent is selected based on preferences of a user of the user device; receiving an authorization request from the user device to display the at least one advertisement; checking if an advertisement campaign account of the at least one advertisement has sufficient budget; and sending an authorization message to the user device, when said campaign account has sufficient budget.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a system for the delivery of advertisement and information thereof in accordance with an embodiment of the invention.

FIG. 2 is a schematic diagram of displays having an advertisement frame in accordance with an embodiment of the invention.

FIG. 3 is a flowchart of the operation of an agent on a user device according to an embodiment of the invention.

FIG. 4 is a flowchart providing detail of the step of selection of an advertisement shown in FIG. 3.

FIG. 5 is a flowchart describing the advertisement management server (AMS) handling of a request for a new advertisement received from a user device according to an embodiment of the invention.

FIG. 6 is a flowchart of the operation of the AMS upon receipt of a request to display an advertisement according to an embodiment of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The techniques disclosed herein include an agent installed on a user device connected to an advertisement management server (AMS). The AMS and the agent cause the display of advertisements based, in part, on control information provided by the agent to the AMS or vice versa, and in particular provide user preferences. The user device periodically pulls from the AMS a new advertisement which is displayed only upon determination that a human is operating the user device. In accordance with certain embodiments a compensation program may be further associated with the user's viewing of the advertisement. The advertisements are displayed on the user device as a standalone application that is operative as long as the user device is on and a connection to the AMS available.

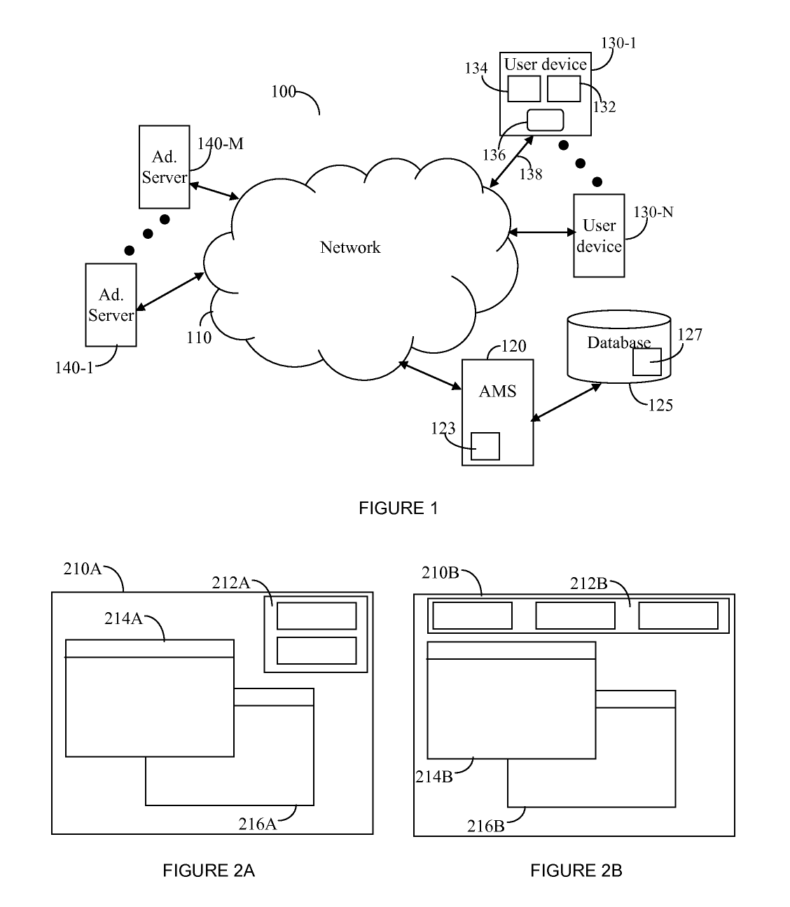

FIG. 1 depicts an exemplary and non-limiting system 100 for the delivery of at least an advertisement and information thereof in accordance with an embodiment of the invention. Components of the system 100 are connected to each other by a network 110. The network 110 may be a local area network (LAN), a wide area network (WAN), a metro area network (MAN), the worldwide web (WWW), the Internet, and or other types of networks and combinations thereof.

An advertisement management server (AMS) 120 is connected to the network 110 and also to a database 125. The AMS 120 operates under the control of a plurality of instructions in memory 123 that when executed by the AMS 120 results in the performance of the methods and actions described herein below in more detail. The memory 123 may be any form of tangible memory.

The database 125, while shown as connected directly to the AMS 120, may, in some embodiments, be connected to the network 110 and be accessible by the AMS 120 there through. It should be further noted that while a single AMS 120 is shown herein, it is possible to operate the system 100 with a plurality of properly synchronized AMSs. The database 125 maybe loaded with a plurality of advertisements and related campaign instructions. The advertisements and the related campaign instructions are provided by advertisers through use of, for example, and without limitation, advertisement servers 140 that contain the advertisements to be displayed. The database 125 may contain a plurality of campaigns from various advertisers. In one embodiment of the invention, metadata is added to each advertisement that may be used to better fit the user's needs and preferences, as further discussed herein below.

The database 125 also contains a utility 127 that upon request by a user, for example, a user from the plurality of user devices 130-1 through 130-N, installs, for example and without limitations, an executable application on the user device for the display of one or more advertisements provided to the user device 130-j using one or more display frames. A user device 130-j (j=1, . . . , N) may be, but is not limited to, a personal computer (PC), a personal digital assistant (PDA), a mobile phone, a smart phone, a tablet computer, and other wired and wireless user devices capable of presenting an advertisement to the user of the user device 130-j. The user devices 130-1 through 130-N communicate with the AMS 120 and the advertisement servers 140-1 through 140-M over the network 110.

For the purpose of illustration the user device 130-1 is shown in greater detail and is comprised of a processing unit 132 connected to a memory 134 and a display 136, and further having a communication interface 138 to the network 110.

In accordance with an embodiment of the invention, the AMS 120 maintains in the memory 123 or database 125 a campaign account and a user account for each user of the user devices. The user account is credited when a user views a particular advertisement and at same time the campaign account of the corresponding advertisement is debited.

In one embodiment of the invention, a user device 130-j is off-line, i.e., not in communication with AMS 120. If such operation is desirable, the AMS 120 downloads, prior to going off-line, to the user device 130-j a plurality of advertisements, from one or more of the advertisement servers 140-1 through 140-M, to be stored thereon. While off-line, the user device 130-j can continue displaying to the user of the user device advertisements in accordance with teachings disclosed herein. Once the device 103-j is on-line, i.e., in communication with the AMS 120, the user device 130-j updates the AMS 120 regarding the viewership of the advertisements stored on the user device 130-j.

FIGS. 2A and 2B show two exemplary and non-limiting displays 210A and 210B each having two windows 214A and 216A on display 210A, and 214B and 216B on display 210B. In addition, a frame 212A is displayed on display 210A and a frame 212B is displayed on display 210B. The frame 212 is displayed on the display responsive of the operation of the utility 127 that installed the appropriate executable application to cause such a display to appear. The user of the user device 130-j can configure the frame to appear in, for example and without limitation, a corner of the display area as shown in frame 212A, or as an elongated rectangle at the top of the display as shown for frame 212B. Other locations throughout the display area 212 are possible, including, but not limited to display of the advertisements in a toolbar like area at any one of the edges of the screen, i.e., top, bottom, left or right, the “toolbar” being dedicated for the display of one or more advertisements at a time. In accordance with a principle of the invention when an application is then displayed in full screen it is actually open only in the area not occupied by the “toolbar”.

In accordance with certain embodiments of the invention, the user can further configure the frame 212 such that it can display one or more advertisements, its size on the display 210, e.g., wide or narrow “toolbar”, the preferred types of advertisements from a content perspective, preferred display times, and the like. An advertisement frame in accordance with the invention may be further placed always on-top as a moveable window, a popup window of one of a plurality of sorts, as well as a screensaver.

The installed executable application, e.g., an agent, on the user device 130-j further monitors that the user device 130-j is in actual use when displaying an advertisement. It should also be noted that more than one frame may be opened on a display. For example, the user may elect to have advertisement “toolbars” at the top and bottom of the screen.

The advertisements are loaded through a pull mechanism (not shown) from the database 125 and stored if so desired, or otherwise required based on metadata and control information associated thereto, onto the user device 130-j. However, the AMS 120 ensures that the display of an advertisement takes place only while sufficient budget exists in the budget allocation provided for the specific advertisement and that the user is also eligible to view such advertisement. It is therefore necessary to have a communication link between the user device 130-j and the AMS 120 to establish a handshake with respect to authorizing the display of a specific advertisement to a user. However, because the advertisement itself was loaded to the user device 130-j upon a first request to display, it is not necessary to download the advertisement in real-time every additional time the advertisement is to be displayed.

In fact, according to the invention, subsequent to a first download of the advertisement, it is only necessary to exchange limited control information, as further explained herein below, and the advertisement itself is displayed from the local memory of the user device 130-j. According to the invention, the agent installed on the user device 130-j does not pull all advertisements to the device at once. Rather, each advertising window opened works using its own logic and pace. For example, when a long narrow advertisement window is open, a pull request for a long narrow advertisement is sent by the agent to the AMS 120. The AMS 120 then receives the request and selects an advertisement to be sent to the requesting user device 130-j from the advertisement database 125. The advertisement is stored for future views on the user device 130-j until the end of the advertisement campaign. When the window's advertising time is up and there is a need for a new advertisement, a request is sent again and the process is repeated.

In accordance with another embodiment of the invention, it is further possible with a first advertisement frame being open on the user device to concurrently have another advertisement frame open, for example, a wide vertical short which requests a wide vertical short advertisement. This frame may request a different type of advertisement that moves at a different pace than the first advertisement window. It will therefore request the next advertisement at a different time. It should be therefore understood that each frame works as an independent advertising unit on the user devices 130-1 through 130-N. The AMS 120 selects the advertisements based, in part, on the preferences of a user of the device 130-j, the campaign settings, the type of the device's display, and properties of the advertising window.

In accordance with an exemplary and non-limiting embodiment of the invention, there are two stages in the type of a request that the advertisement window frame performs: at first the advertisement frame requests new advertisements from the AMS 120 every time it needs to show an advertisement. This is repeated until the stack respective of at least the window frame is full. In a configuration of the invention, the stack size is dynamic and changes depending on the amount of advertising windows a user device 130-j has open. That is, the more window frames open the more memory space is allocated for the stack. Hence, while in one embodiment a single stack is associated with all of the window frames, in another embodiment, each window frame has its own stack. According to an embodiment of the invention, the stack size is defined by the advertiser, rather than by specific advertisement formats. Specifically, one advertiser may have several different formats, and therefore even if the stack is full and, for example, a vertical long window requests an advertisement, it may still be downloaded for an advertiser who's advertisement already exists in the stack in a different format. This ensures that advertisements of an advertiser are viewed for a decent amount of time by the user, rather than having too many different advertisers and a user viewing an advertisement only a few times. Clearly, this is dependent on the number of advertising slots available and is dynamically configured. The growth of stack size may be a function of several parameters and may have different implementations which would now be clear to those of ordinary skill in the art to develop and are therefore included herein as part of the invention. Once the stack is full, i.e., it has reached its maximum allowable size, either temporarily, until such time that it is made to grow, or permanently, the requests to the AMS 120 are only for viewing confirmation requests. That is, no requests are made for new advertisements.

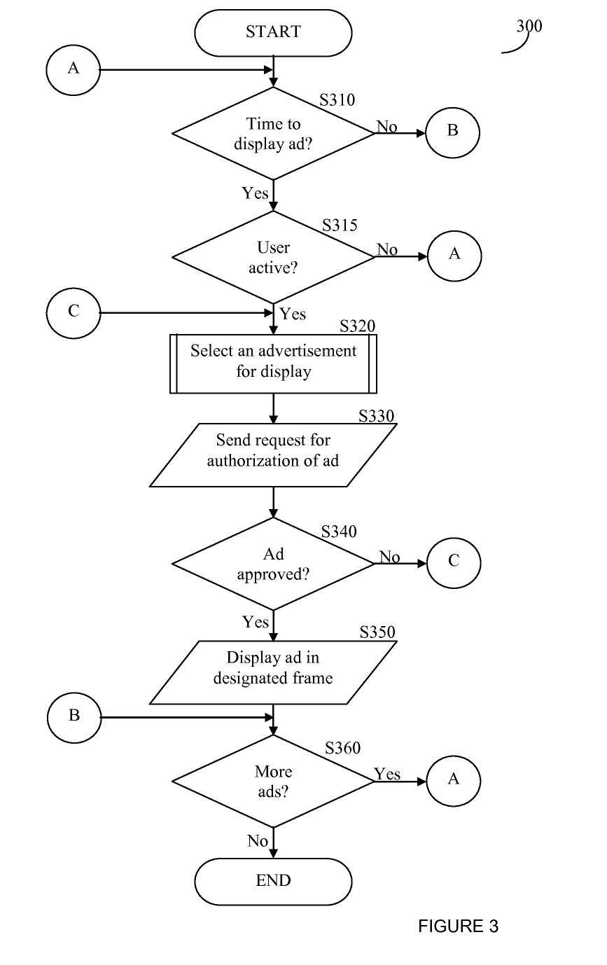

FIG. 3 depicts an exemplary and non-limiting flowchart 300 of the operation of an agent on a user device 130-j, in accordance with an embodiment of the invention. In S310, it is checked whether it is time to display an advertisement, and if so execution continues with S315; otherwise, execution continues with S360. Such a check is performed by each window frame active on the user device 130-j, under the control of the agent, and preferably independent of each other.

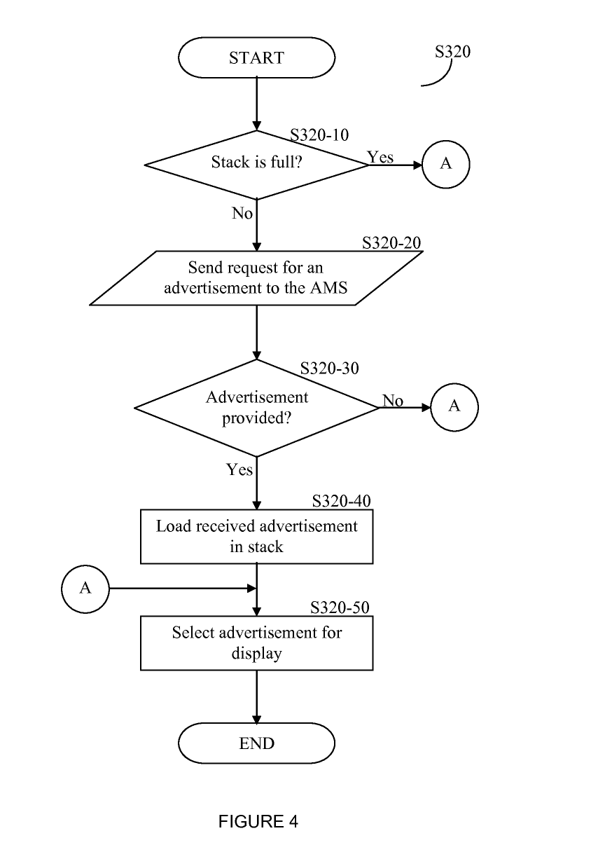

In S315, it is checked whether the user is active on the user device 130-j, and if so execution continues with S320; otherwise, execution returns to S310. The determination of a user being active on the user device may be made by detecting certain inputs, such as, but not limited to, clicks, mouse movements, keypad strokes, clicks on a touch-screen, and inactivity of a screen saver which can all be, without limitation, elements of such determination. In S320, an advertisement is selected from the plurality of advertisements downloaded into the user device's memory. A more detailed description of S320 is shown with respect of FIG. 4.

In S330, a check request is sent from the user device 130-j to the AMS 120 to check whether the selected advertisement has sufficient funds that would allow for the display of the selected advertisement to a particular user. It should be noted that additional checks may be made here, for example but not by way of limitation, it can also be checked if the user has been displayed the advertisement for more than a threshold value, and if so to not allow the display of the advertisement. The threshold value is preconfigured, for example, by a campaign manager. Another possibility for not authorizing a display of an advertisement to a user is when it is known that the advertisement resulted with a sale for that user and the advertiser defines in the campaign information that there is no interest in continuing to display the advertisement to such a user in such circumstances. Yet another possibility is to not display a previously displayed advertisement due to changes in the user's preferences.

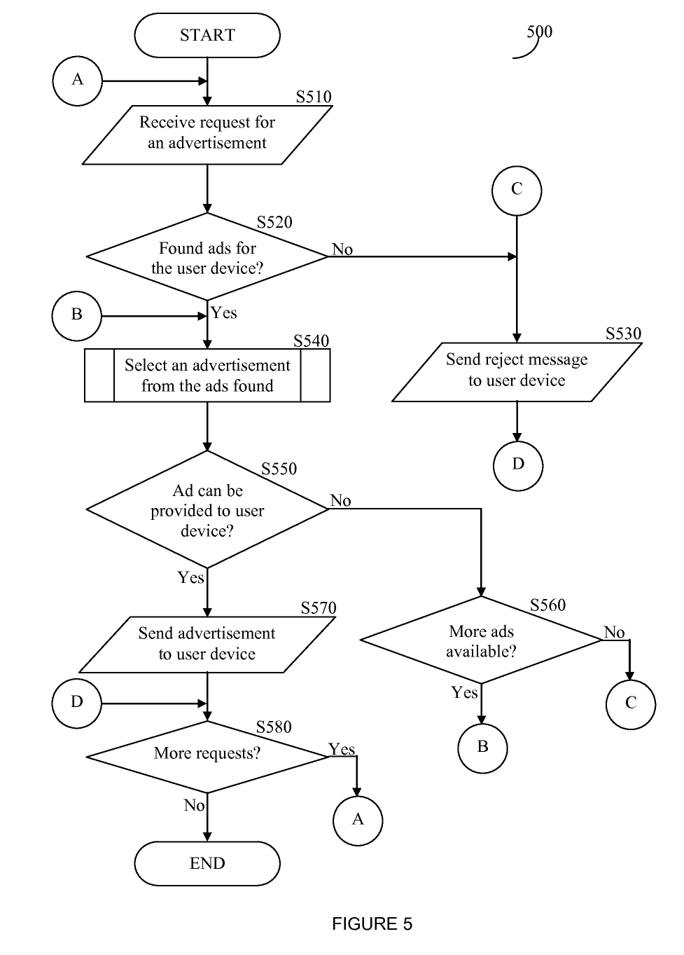

In S340 it is checked whether the response received from the AMS 120 responsive of the request is an approval for display and if so, execution continues with S350; otherwise, execution continues with S320, for selecting another advertisement and continuing the process therefrom. A more detailed description of the operation respective of a user device request for an advertisement is further discussed with respect to FIG. 5.

In S350, the advertisement is displayed in the frame for a duration that may be predefined, for example, by a campaign manager according to the user's preferences. In S360, it is checked whether more advertisements are to be displayed, and if so execution continues with S310; otherwise, execution terminates. In accordance with an embodiment of the invention, a request for an advertisement or confirmation thereto for viewing an advertisement is sent to the AMS 120 only in the case where the user interacts with the device 130-j, i.e., when the advertisement is actually viewed. When a viewing is confirmed, the advertiser's budget, for example, on the AMS 120, is accordingly reduced and the user, as may be applicable, receives credits. In the case where an advertisement did not reach a predefined minimum viewing time, as determined for example by the advertisement's meta info, an “undo” request is sent to the AMS 120, that reverses the debit and credit process. This process therefore ensures that the budget usage is within its limits and predefined financial and exposure goals. In another embodiment of the method, upon completion of the display of the advertisement to the user on the user device 130-j, and further determination that a user actually viewed the advertisement based on specific criterions used, a notification may be sent to the AMS 120 indicating such successful display, causing the reduction of the display cost from the campaign budget. In yet another embodiment, credits are issued in favor of the user who viewed the advertisement on user device 130-j. Such credits may be used to provide such a user with various advantages such as coupons, refunds, payments, free or discounted tickets, and other forms of compensation and/or benefits.

FIG. 4 is an exemplary and non-limiting flowchart of S320 illustrating the selection process of an advertisement shown in FIG. 3. In S320-10, it is checked whether the advertisement stack of the user device 130-j is full and if not, execution continues with S320-20; otherwise, execution continues with S320-50. In S320-20, a request is sent to the AMS 120 to provide an advertisement. The idea is to ensure that the advertisement stack of the user device 130-j continues to fill up with new advertisements as long as it is not full. In S320-30, it is checked whether an advertisement is provided by the AMS 120. As will be further described with respect to FIG. 5 below, it is possible that no appropriate advertisement will be found at any given point in time for the specific user device 130-j, for example, due to preferences of that specific user. In such a case, no advertisement will be provided. Other reasons may of course also lead to an inability to provide an advertisement to the user by the AMS 120. Therefore, if an advertisement is provided then execution continues with S320-40; otherwise, execution continues with S320-50. In S320-40, the received advertisement is loaded into the advertisement stack of the user device 130-j. In S320-50, an advertisement is selected for display from the advertisements in the advertisement stack. In one embodiment of the invention preference is given to display the most recently loaded advertisement, however, other algorithms for selecting an advertisement for display may be used without departing from the scope of the invention.

FIG. 5 depicts and exemplary and non-limiting flowchart 500 describing the handling of a request for a new advertisement from a user device 130-j by the AMS 120 according to an embodiment of the invention. In S510, the AMS 120 receives a request for an advertisement from a user device 130-j. In S520, it is checked whether one or more appropriate advertisements were found responsive of the request, and if so execution continues with S540; otherwise, execution continues with S530 where a rejection notification is sent to the user device 130-j notifying the user device 130-j that no advertisement is sent responsive of the received requests, after which execution continues with S580.

In S540, an advertisement is selected from the one or more advertisements that were found responsive of the request. It should be noted that the found advertisements typically correspond to the preferences of the user of user device 130-j. The selection of a particular advertisement may be, for example, and without limitation, a random selection from the list of available advertisements for the user device 130-j, the least recently provided advertisement, the highest return to the advertiser advertisement, and so on and so forth. In S550, it is checked whether the advertisement can be provided to the user. For example and without limitation, the advertisement may not have sufficient budget for display to any user or for that particular user, or the advertisement was already displayed or otherwise distributed to a number of user devices identified in advance with respect to a particular campaign, and so on and so forth. If the advertisement can be sent to the user device 130-j, then execution continues with S570; otherwise, execution continues with S560 where it is checked whether additional advertisements are available for the user device 130-j, and if so execution continues with S540; otherwise, execution returns to S530.

In S570, the selected advertisement is sent to the user device 130-j. In S580, it is checked whether more requests are to be handled, and if so execution continues with S510; otherwise, execution terminates.

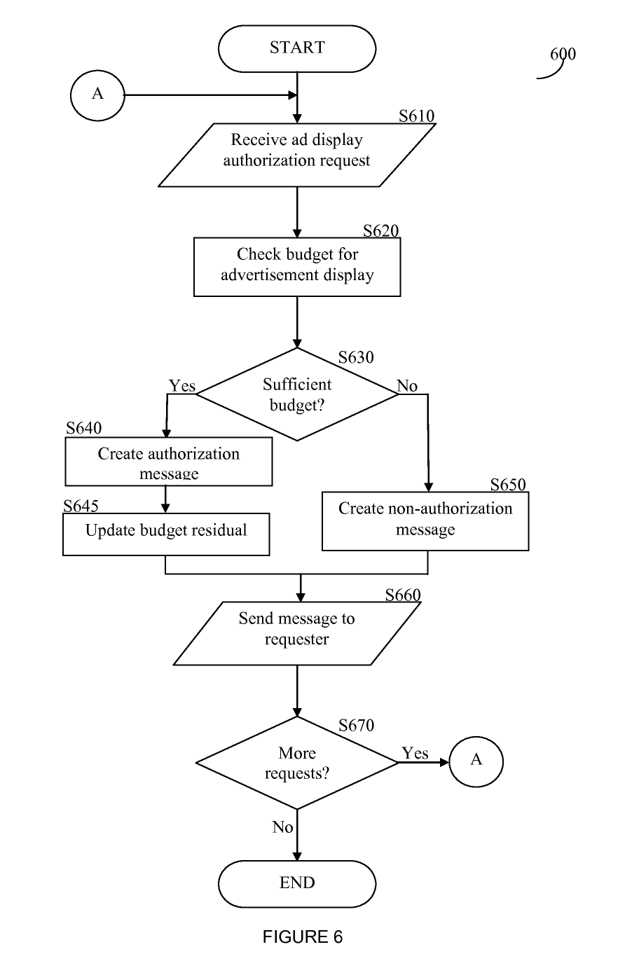

In FIG. 6 there is shown an exemplary and non-limiting flowchart 600 of the operation of the AMS 120 upon receipt of a request to display an advertisement according to an embodiment of the invention. In S610, the AMS 120 receives a request for authorization from a user device 130-j to display a specific advertisement. In one embodiment, the user information is also provided for the purposes discussed in more detail above. In S620, the budget available for the advertisement is retrieved from the database 125. In S630, it is checked whether there are sufficient funds in the budget to display the advertisement to the user, and if so execution continues with S640; otherwise, execution continues with S650. The budget is saved in a campaign account of the advertisement to be displayed. While a financial check is discussed herein, other checks may be performed without departing from the scope of the invention. For example, another check that may be performed is a rating check, as well as others.

In S640 an authorization message is created followed by S645 where the budget allocated for the advertisement is updated, i.e., the budget is reduced resulting from the authorization. In S650, a non-authorization message is created. In S660, the message created in either S640 or S650 is sent to the user device 130-j that requested the authorization. In S670, it is checked whether there are more requests, and if so execution continues with S610; otherwise, execution terminates.

In one embodiment of the invention, instead of an advertisement the user is prompted with a notification requesting the user to provide an approval to show a specific advertisement at a specific period of time. For example, the prompt in the window frame may ask the user to acknowledge willingness to view a presidency candidate's address on a certain date at a certain time. If the user acknowledges the display then at the due time the advertisement is displayed responsive of a request to the AMS 120 to send or otherwise authorize the display of the advertisement. Typically, such notifications not loaded to the stack and are aired only once. In yet another embodiment of the invention, the frame used to display advertisements allows interaction of the viewer with the advertiser to allow back and forth communication and exchange of data, responses, and displays. For that purpose, a communication session is enabled between the window frame and the advertisement server to enable exchange of information and display within the framework of the window frame.

The principles of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A user device for display of advertisements, comprising:
a memory for storing an agent, the agent allowing a user of the user device to cause the display of at least a window frame;
a processing unit for execution of at least the agent;
a network interface connected to the processing unit for accessing at least an advertisement management server (AMS) for retrieving at least one advertisement and corresponding metadata, wherein the retrieved advertisement and corresponding metadata are saved in the memory;
a display connected to the processing unit and the memory for the display of the at least an advertisement stored in the memory on at least one window frame activated by the agent of the user device, wherein the agent causes to display of the at least one advertisement on the at least one window frame opened by the agent upon determination that the user is interacting with the user device, wherein the agent generates a message of consumption respective of consumption of the at least one advertisement by the user of the user device.

2. The user device of claim 1, wherein the user device is one of: a personal computer (PC), a personal digital assistant (PDA), a smart phone, a cell phone, and a tablet computer.

3. The user device of claim 1, wherein the message of consumption is sent to the AMS at one of: at the beginning of the consumption of the advertisement on the window frame, and at the end of the consumption of the advertisement on the window frame.

4. The user device of claim 3, wherein the agent sends an undo message to the AMS when consumption of the at least one advertisement is below a required advertisement consumption as provided by metadata associated with the at least an advertisement.

5. The user device of claim 4, when sending the undo message, at least one of the following is to be performed by the AMS: an advertisement campaign account is credited with a consumption fee for the at least one advertisement, and a user account is debited from a previously made respective credit, wherein the advertisement campaign account and the user account are maintained in the AMS.

6. The user device of claim 3, when sending the message of consumption, one of the following is to be performed by the AMS: a campaign account is debited with a consumption fee for the advertisement, and a user account is credited from a previously made respective credit.

7. The user device of claim 1, wherein the at least one window frame is displayed on the display of the user device in at least one of: at a user desirable location, at a user desirable time, at a user desirable interval of time, and at a user desirable frequency.

8. The user device of claim 1, wherein the at least one advertisement can pre-loaded to the memory for display when the user device is not in communication with the AMS.

9. The user device of claim 8, wherein upon commencement of communication with the AMS at least a consumption message respective of the at least an advertisement is sent to the AMS by the user device.

10. The user device of claim 1, wherein the at least one advertisement pulled for the at least one window frame is selected based on its fitness for display on the at least one window frame, wherein the window frame is configurable by the user of the user device.

11. The user device of claim 1, wherein the at least one advertisement enables interaction between the viewer and the advertisement.

12. The user device of claim 1, wherein a communication session between the user device and an advertisement server of the advertisement is enabled within a framework of the at least one window frame.

13. A method for displaying advertisements on a user device comprising:
generating at least one window frame on the user device by an agent, wherein the at least one window frame is configurable by a user of the user device;
periodically communicating with an advertisement management server (AMS) requesting to provide at least one advertisement and its associated metadata;
displaying, upon determination that a user is interacting with the user device, the at least one advertisement on the at least one window frame based in part on the metadata; and
generating a message of consumption for debiting an advertisement campaign account of the at least one advertisement for the viewing of the at least one advertisement and for crediting a user account of the user for the viewing of the at least one advertisement; and
sending the message of consumption to the AMS.

14. The method of claim 13, further comprising:
sending a request to the AMS to download the at least one advertisement; and
sending an authorization request to the AMS to view the advertisement.

15. The method of claim 13, wherein the message of consumption is sent at one of: at the beginning of the consumption of the at least one advertisement on the window frame, and at the end of the consumption of the at least one advertisement on the window frame.

16. The method of claim 15, wherein further comprising:
sending an undo message to the AMS if consumption is below a required advertisement consumption as provided by the metadata associated with the at least an advertisement.

17. The method of claim 16, wherein upon sending the undo message further comprising:
crediting the advertisement campaign account with the consumption fee for the advertisement; and
debiting the user account with the consumption fee for the advertisement; wherein the advertisement campaign account and the user account are maintained in the AMS.

18. The method of claim 13, further comprising:
placing the window frame at a user desirable location on the display of the user device.

19. The method of claim 13, wherein the at least one advertisement pulled for the at least one window frame is selected based on its fitness for display on the at least one window frame, wherein the window frame is configurable by a user of the user device.

20. The method of claim 13, further comprising:
providing a communication session between the user device and an advertisement server of the advertisement within a framework of the at least one window frame.

21. A non-transitory computer readable medium having stored thereon instructions for causing one or more processing units to execute the method according to claim 13.

22. A method for authorization the display of advertisements on at least one user device, the method is performed by an advertisement management server (AMS), comprising:
sending at least one advertisement and associated metadata to a user device requesting the at least one advertisement, wherein the at least one advertisement being sent is selected based on preferences of a user of the user device;
receiving an authorization request from the user device to display the at least one advertisement;
checking if an advertisement campaign account of the at least one advertisement has sufficient budget; and
sending an authorization message to the user device, when said campaign account has sufficient budget.

23. The method of claim 22, further comprising:
receiving a message of consumption;
debiting the campaign account of the at least one advertisement for the viewing of the at least one advertisement; and
crediting a user account of the user for the viewing of the at least one advertisement.
